(19) United States
(12) Patent Application Publication
(10) Pub. No.: US 2018/0296026 A1
(43) Pub. Date: Oct. 18, 2018

(54) COFFEE MACHINE BOILER STRUCTURE CAPABLE OF AUTOMATIC DEPRESSURIZATION

(71) Applicant: Hsien-Chi TSENG, Taipei City (TW)

(72) Inventor: Hsien-Chi TSENG, Taipei City (TW)

(21) Appl. No.: 15/947,154

(22) Filed: Apr. 6, 2018

(30) Foreign Application Priority Data
Apr. 12, 2017 (TW) 106205066

(51) Int. Cl. A47J 31/54

(52) U.S. Cl. CPC A47J 31/545; A47J 31/58

(57) ABSTRACT

The present invention provides a boiler structure, for use with a coffee machine and capable of automatic depressurization, comprising a lid, a sealing member, a boiler body, and a position-limiting support frame. The lid is configured with a water inlet pipe and a water outlet pipe and the water outlet pipe. The sealing member is fitted in an inner side of the lid and having a pressure relief ring, wherein the pressure relief ring has one or a plurality of pressure relief apertures at a pressure relief height. The boiler body is on one side of the lid, wherein the boiler body comprises a receiving space and an opening. The receiving space is in communication with the water inlet pipe and the water outlet pipe, and the opening is on one side of the receiving space. A heating device is on one side of the boiler body. The boiler body is movable downward by pressure while being heated by the heating device; and, when the opening of the boiler body reaches the pressure relief height, the pressure is relieved. The position-limiting support frame is on the side of the lid such that the boiler body lies between the position-limiting support frame and the lid and is limited in displacement.

### BACKGROUND OF THE INVENTION

### 1. Technical Field

The present invention relates to a boiler structure and more particularly to one for use with a coffee machine and having an automatic depressurization mechanism to prevent explosion and thereby ensure safety of use.

### 2. Description of Related Art

Recently, drinking coffee or tea has become a favorite pastime of many as a result of commercial advertisements, as a symbol of fashion, or simply to relieve pressure from daily life.

Conventionally, a brewing apparatus for preparing coffee, tea, or other drinks (e.g., a coffee machine) requires a pump for guiding water from an external source into a boiler, where the water is heated to a specific temperature by a heating device such as a heater or heat exchanger. The hot water in the boiler is then discharged through a pipe and mixed with the desired beverage ingredient(s) to make the intended beverage.

While the boiler is heated by the heating device, the pressure inside the boiler increases with water temperature. If the hot water or pressure in the boiler is not released in a timely manner after the boiler temperature or pressure enters a certain range, the boiler may explode like a bomb at any time, which is extremely dangerous.

In light of the various drawbacks of the boiler of the conventional brewing apparatus described above, the inventor of the present invention thought it necessary to design a boiler having an explosion-proof safety mechanism capable of properly adjusting the pressure inside the boiler so that the boiler is enhanced in safety and will not explode due to an exceedingly high internal pressure.

### BRIEF SUMMARY OF THE INVENTION

The primary objective of the present invention is to solve the problem of the conventional coffee machine boilers that they may deform or even explode when overly pressurized due to the lack a safety mechanism for pressure management.

To address the above problems, the present invention provides a boiler structure, for use with a coffee machine and capable of automatic depressurization, wherein the coffee machine has a water inlet and a water outlet, and the boiler structure is between the water inlet and the water outlet; and, the boiler structure being characterized by comprising a lid, a sealing member, a boiler body, and a position-limiting support frame. The lid is configured with a water inlet pipe and a water outlet pipe, wherein the water inlet pipe is configured for guiding water from the water inlet and the water outlet pipe is configured for guiding water to the water outlet. The sealing member is fitted in an inner side of the lid and having a pressure relief ring, wherein the pressure relief ring has one or a plurality of pressure relief apertures at a pressure relief height. The boiler body is on one side of the lid, wherein the boiler body comprises a receiving space and an opening. The receiving space is in communication with the water inlet pipe and the water outlet pipe, and the opening is on one side of the receiving space 31. The pressure relief ring is fitted in the opening to seal the opening. A heating device is on one side of the boiler body. The boiler body is movable downward by pressure while being heated by the heating device, and steam is allowed to be released from inside of the boiler body through the one or the plurality of pressure relief apertures when the opening of the boiler body reaches the pressure relief height, thereby relieving the pressure. The position-limiting support frame is on the side of the lid such that the boiler body lies between the position-limiting support frame and the lid and is limited in displacement.

Furthermore, the water inlet pipe is connected to a water tank.

Furthermore, the heating device is a thermosiphon.

Furthermore, the water inlet pipe includes a water inlet section in communication with the water tank, a water outlet section in communication with the receiving space of the boiler body, and a preheating section between the water inlet section and the water outlet section and on one side of the heating device, so that water heated by the preheating section can be guided into the receiving space via the water outlet section.

Furthermore, a check valve is installed between the water inlet section and the heating device.

Furthermore, a pressure control device is installed in one side of the boiler body, when the boiler body descends to a triggering height, the pressure control device turns off the heating device to stop the heating device from heating the boiler body

Furthermore, the boiler body descends to the triggering height, the opening of the boiler body is higher than the pressure relief height.

Furthermore, a sealing valve is at one end of the water inlet pipe and includes a pressing member located in the receiving space; a plurality of through holes are in the wall of the water inlet pipe for guiding water into the receiving space; and, when the pressing member is displaced toward the lid, the lid will block the through holes.

Furthermore, the lid is peripherally configured with one or a plurality of position-limiting members and the one or a plurality of position-limiting members is apart from the inner side of the lid; and, the positioned-liming support frame is configured with one or a plurality of stopping member peripherally so that the one or a plurality of position-limiting members are engaged with the one or a plurality of stopping members respectively to support the position-limiting support frame.

Furthermore, the boiler body is configured between the lid and the position-limiting support frame is peripherally configured with one or a plurality of outwardly extending members movably disposed in the space.

Furthermore, an inner bottom side and an inner vertical wall of the boiler body are joined by a curved surface.

Furthermore, the boiler body further comprises a partitioning member inside; the partitioning member forms a steam generation area and a hot water generation area in the boiler body, wherein the steam generation area and the hot water generation area being concentric with the boiler body; the water inlet pipe is in communication with the steam generation area in order to guide water into the steam generation area; the water outlet pipe is in communication with the hot water generation area in order to guide hot water out of the hot water generation area; at least one heater is configured in the steam generation area to generate steam by heating the water in the steam generation area in a concentrated manner; and, the heating device heats the water in the hot water generation area continuously to generate hot water.

Furthermore, the position-limiting support frame is a boiler housing.

The present invention is advantageous over the prior art in that:

1. The boiler body in the present invention is displaceable with respect to the lid. Once the boiler body is displaced, leaving a gap between the boiler body and the sealing member, the pressure inside the boiler body can release through the gap to prevent the boiler from explosion.

2. According to the present invention, water is fed into and let out of the boiler body under the control of a pressure control device. By keeping the pressure and temperature of brewing water within predetermined ranges respectively, the quality of the coffee brewed with the brewing water will be enhanced.

3. Pumps can be dispensed with because a thermosiphon is provided in the present invention to guide water flow. In addition, as water is preheated before entering the boiler body, the time required for the heating device to heat the boiler body is effectively shortened.

### BRIEF DESCRIPTION OF THE SEVERAL VIEWS OF THE DRAWINGS

FIG. 1 schematically shows the overall structure of a coffee machine according to the present invention;

FIG. 2 is a partially sectional side view of a boiler structure according to the present invention;

FIG. 3 is a partial enlarged view of the boiler structure in FIG. 2;

FIG. 4 is another partial enlarged view of the boiler structure in FIG. 2;

FIG. 5-1 is a partial enlarged view showing the sealing valve in the present invention before it is displaced;

FIG. 5-2 is similar to FIG. 5-1 except that the sealing valve has been displaced;

FIG. 6-1 is a drawing showing how the boiler structure in FIG. 2 works;

FIG. 6-2 is another drawing showing how the boiler structure in FIG. 2 works; and

FIG. 6-3 is still another drawing showing how the boiler structure in FIG. 2 works.

### DETAILED DESCRIPTION OF THE INVENTION

The details and technical solution of the present invention are hereunder described with reference to accompanying drawings. For illustrative sake, the accompanying drawings are not drawn to scale. The accompanying drawings and the scale thereof are restrictive of the present invention.

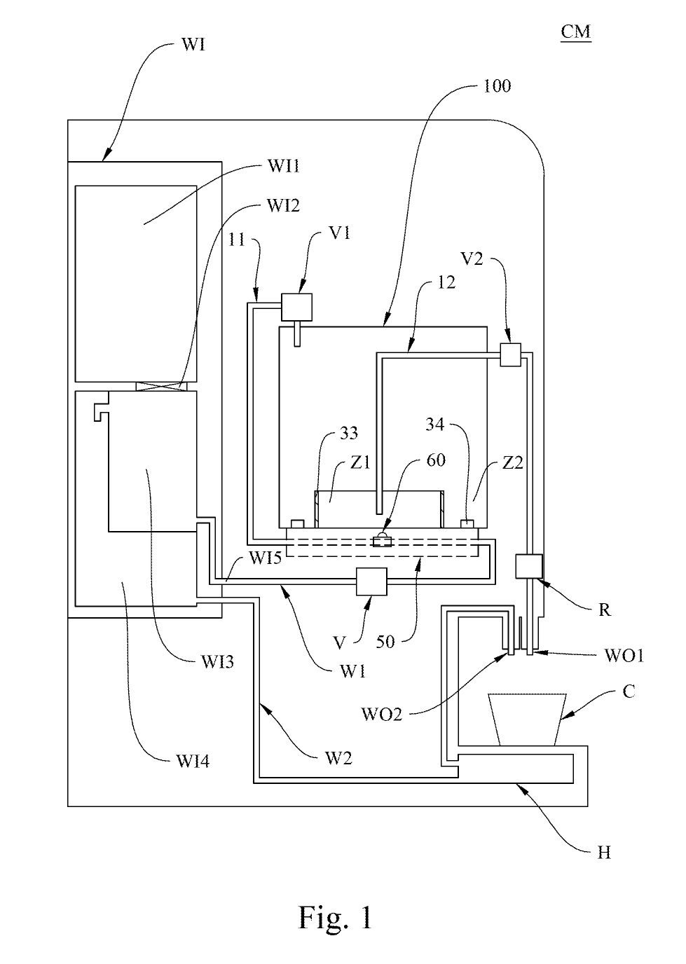

A preferred embodiment of the present invention is described below. Please refer to FIG. 1, which schematically shows the overall structure of a coffee machine according to the present invention.

The present invention discloses a boiler structure 100 for use with a coffee machine CM and capable of automatic depressurization. The coffee machine CM, can be used to prepare various types of coffee such as Americano and espresso. In a preferred embodiment, the coffee machine CM has a water tank WI for receiving the water. Two water boiling paths, namely a pressure-based water boiling path and a heat-based water boiling path, are provided downstream of the water tank WI of the coffee machine CM to boil water by different methods respectively. The pressure-based water boiling path is used to brew a small amount of coffee, whereas the heat-based water boiling path can add water to, and thereby adjust the strength of, the coffee brewed. In another preferred embodiment, the coffee machine CM does not include the water tank WI. Water can be artificially added or provided by the water supply pipeline to enter the coffee machine CM, wherein the water includes cold water or heated warm water or hot water; the present invention has no limitation.

The following is the detailed description for the preferred embodiment that the coffee machine CM has water tank WI:

The pressure-based water boiling path of the coffee machine CM includes the water tank WI, a water inlet WI5, a water outlet WO1, and the boiler structure 100, which is between the water inlet WI5 and the water outlet WO1. The heat-based water boiling path of the coffee machine CM includes the water tank WI, another water outlet WO2, and a heater H between the water tank WI and the water outlet WO2. The water tank WI includes a water inlet portion WI1 connected to an external water flow, a filter portion WI2 for filtering water, a brewing water container WI3, and a water container WI4 for coffee strength adjustment. The brewing water container WI3 has a first pipe WI for supplying water to the pressure-based water boiling path. The water container WI4 for coffee strength adjustment has a second pipe W2 for supplying water to the heat-based water boiling path. When water introduced into the brewing water container WI3 exceeds the capacity of the brewing water container WI3, the excess water is guided into the water container WI4 for coffee strength adjustment and serves to adjust the strength of the coffee brewed. The volume of the brewing water container WI3 can be planned according to manufacture or design requirements; the present invention has no limitation in this regard.

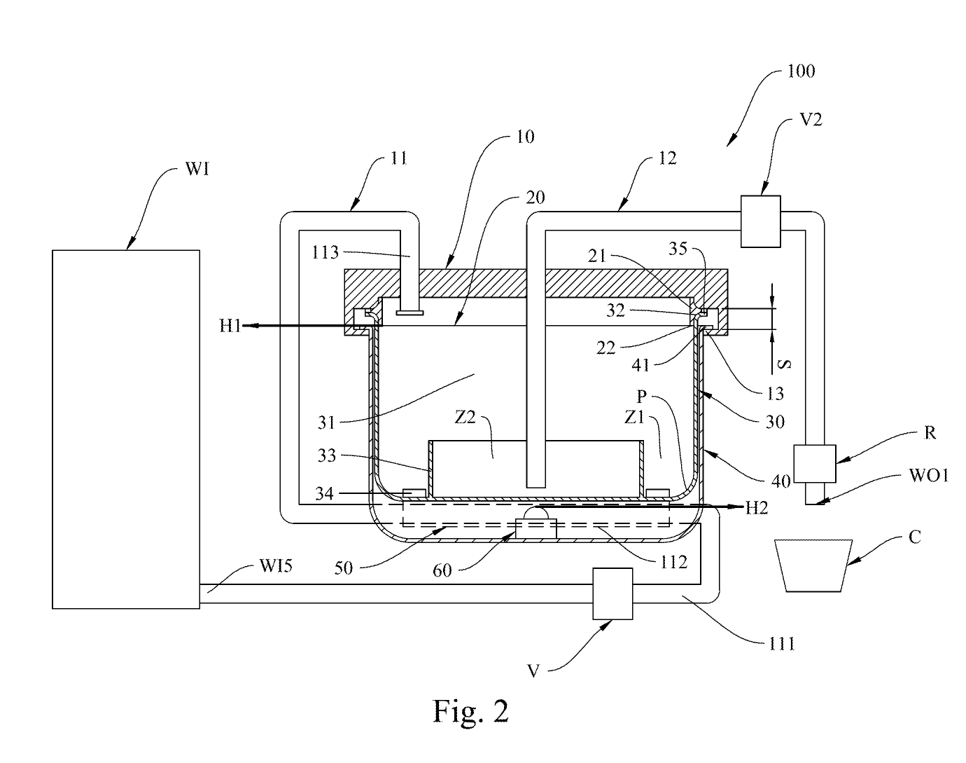

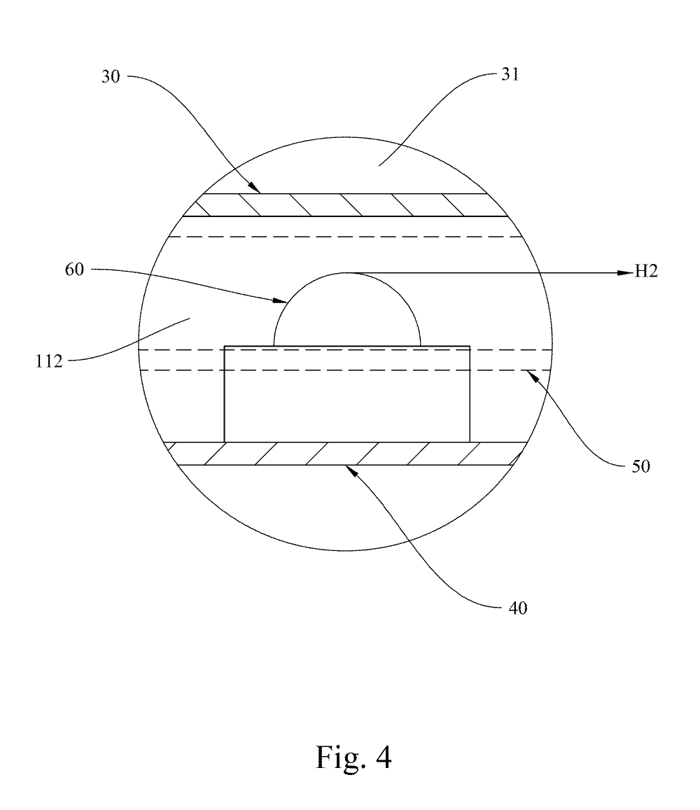

Please refer now to FIG. 2 to FIG. 4, which show sectional views of the disclosed boiler structure.

In the pressure-based water boiling path as shown in FIG. 2 to FIG. 4, a heating device 50 can produce a thermosiphon effect on the water in the pipe such that the water in the water tank WI flows through the water inlet WI5 and is thus preheated by the heating device 50. The preheated water is guided into the boiler structure 100 via a water inlet pipe 11 of the boiler structure 100 while the boiler structure 100 is heated by the heating device 50, which is on one side of the boiler structure 100. The hot water in the boiler structure 100 is then guided through a water outlet pipe 12 of the boiler structure 100 into an ingredient holding mechanism R connected to the water outlet WO1, wherein the ingredient holding mechanism R is loaded with the ground coffee to be infused. Coffee is brewed while hot water is introduced into the ingredient holding mechanism R from the water outlet pipe 12, and the brewed coffee is guided into a container C through the water outlet WO1.

In a preferred embodiment, the heating device 50 is a thermosiphon for generating a thermosiphon effect that guides water into the boiler body 30 of the boiler structure 100, and the heating device 50 heats the water in the receiving space 31 of the boiler body 30 at the same time. The water inlet pipe 11 includes a water inlet section 111 in communication with the water tank WI, a water outlet section 113 in communication with the receiving space 31 of the boiler body 30, and a preheating section 112 between the water inlet section 111 and the water outlet section 113 and on one side of the heating device 50, so that water heated through the preheating section 112 can be guided into the receiving space 31 via the water outlet section 113. The introduction of preheated water helps shorten the time required for the heating device 50 to heat the boiler body 30, and heating efficiency is enhanced as a result.

A check valve V is installed between the water inlet section 111 for the heating device 50 to guide water from the water tank WI into the boiler body 30 and prevent water from flowing back to the water tank WI. The check valve V is open when strong siphon suction takes place, allowing water to flow through the pipe. While the heating device 50 is heating the water in the preheating section 112, pressure increases with water temperature and consequently closes the check valve V, preventing the unheated water in the water inlet section 111 from entering the preheating section 112, and the hot water in the preheating section 112 from flowing back into the water inlet section 111. In a preferred embodiment, the check valve V is configured to be closed by a buoyant force and be closed even tighter by the pressure generated from the water heated by the heating device 50.

The boiler structure 100 includes a lid 10, a sealing member 20, a boiler body 30 and a position-limiting support frame 40. The lid 10 is configured with the water inlet pipe 11, which is configured for guiding water from the water inlet WI5, and the water outlet pipe 12, which guides water to the water outlet WO1. The position-limiting support frame 40 is on one side of the lid 10. The boiler body 30 is between the position-limiting support frame 40 and the lid 10 and is therefore displaceable only to a limited extent. In a preferred embodiment, the position-limiting support frame 40 is a boiler housing. The lid 10 is peripherally configured with one or a plurality of position-limiting members 13 that are spaced apart from the inner side of the lid 10 by a space S. The position-limiting support frame 40, on the other hand, is peripherally configured with one or a plurality of stopping members 41. The one or more position-limiting members 13 are engaged with the one or more stopping members 41 respectively to provide support for the position-limiting support frame 40. Also, the boiler body 30, which is configured between the lid 10 and the position-limiting support frame 40, is peripherally configured with one or a plurality of outwardly extending members 35 movably disposed in the space S so that the boiler body 30 can be displaced to adapt to pressure variation in the receiving space 31.

In a preferred embodiment, the sealing member 20 is fitted in the inner side of the lid 10 when the lid 10 and the boiler body 30 are put together. The sealing member 20 has a pressure relief ring 21. The pressure relief ring 21 has one or a plurality of pressure relief apertures 22 at a pressure relief height H1. The boiler body 30 is on one side of the lid 10 and includes the receiving space 31, which is in communication with the water inlet pipe 11 and the water outlet pipe 12, and an opening 32 provided on one side of the receiving space 31. The pressure relief ring 21 is fitted in the opening 32. The provision of the pressure relief ring 21 is intended to bring the receiving space 31 into a sealed state. The boiler body 30 can be moved downward by pressure while being heated by the heating device 50, which is provided on one side of the boiler body 30, and once the opening 32 of the boiler body 30 reaches the pressure relief height H1, the steam in the boiler body 30 is released through the one or more pressure relieve apertures 22 to relieve the pressure. The sealing member 20 may be an annular gasket or sealing cover configured on the inner side of the opening 32 or any other mechanism capable of sealing the opening 32 of the boiler body 30 hermetically; the present invention has no limitation in this regard. In another preferred embodiment, the sealing member 20 is mounted around the outer periphery of the opening 32 to provide airtightness.

In a preferred embodiment, the boiler body 30 further comprises a partitioning member 33. The partitioning member 33 forms a steam generation area Z1 and a hot water generation area Z2 in the boiler body 30, with the steam generation area Z1 and the hot water generation area being concentric with the boiler body 30. The water inlet pipe 11 is in communication with the steam generation area Z1 in order to guide water into the steam generation area Z1. The water outlet pipe 12 is in communication with the hot water generation area Z2 in order to guide hot water out of the hot water generation area Z2. At least one heater 34 is configured in the steam generation area Z1 to generate steam by heating the water in the steam generation area Z1 in a concentrated manner. The heating device 50 on one side of the boiler body 30 heats the water in the hot water generation area. Z2 continuously to generate hot water. In another preferred embodiment, the pressure in the boiler body 30 is detected by an air pressure sensor (or temperature sensor) and a controller or control unit connected to the air pressure sensor (or temperature sensor), and the flow rate of water is controlled by a pump. In that case, there is no need to provide the partitioning member 33 in the boiler body 30, and steam and hot water can be generated just as well by injecting water into the receiving space 31 and heating the water with the heating device 50.

In a preferred embodiment, the inner bottom side and the inner vertical wall of the boiler body 30 are joined by a curved surface P. As previously mentioned, the internal pressure of the boiler body 30 increases with the water temperature in the boiler body 30 while the heating device 50 is in operation. The curved surface P can prevent the internal pressure from concentrating at any corner of the boiler body 30 and thereby protect the boiler body 30 from damage. The curvature of the curved surface P can be planned according to manufacture or design requirements; the present invention has no limitation in this regard.

In addition, a pressure control device 60 is installed in one side of the boiler body 30. When the boiler body 30 descends to a triggering height H2, the pressure control device 60 turns off the heating device 50 to stop the heating device 50 from heating the boiler body 30. Meanwhile, the pressure control device 60 opens a water outlet valve V2 in the water outlet pipe 12 to guide water out of the receiving space 31. It is worth mentioning that, when the descending boiler body 30 reaches the triggering height H2, the opening 32 of the boiler body 30 is still higher than where the one or more pressure relief apertures 22 are provided, i.e., higher than the pressure relief height H1; as a result, the receiving space 31 remains sealed. The pressure control device 60 may be a pogo pin, a memory-metal member, or any other devices capable of detecting pressure variation in the boiler body 30; the present invention has no limitation in this regard.

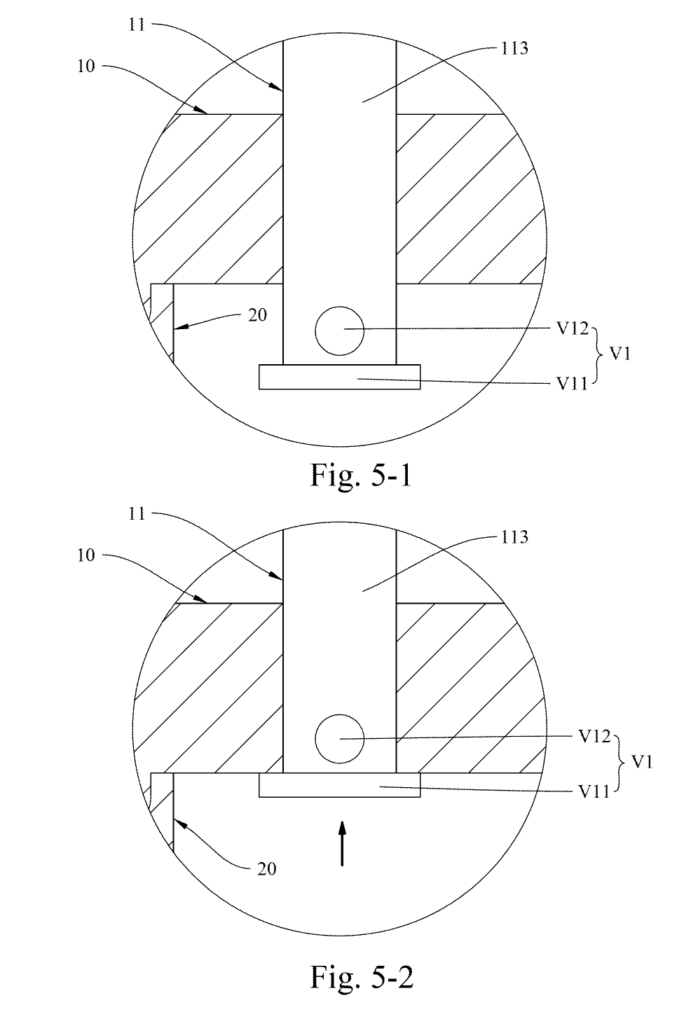

Please refer to FIG. 5-1 and FIG. 5-2 for two partial enlarged views that show the sealing valve in the present invention before and after displacement respectively.

A sealing valve V1 is at one end of the water inlet pipe 11 and includes a pressing member V11 located in the receiving space 31. A plurality of through holes V12 are in the wall of the water inlet pipe 11 (and hence on one side of the pressing member V11) for guiding water into the receiving space 31. When subjected to the pressure in the receiving space 31, the pressing member V11 can be displaced toward the lid 10 such that the lid 10 blocks the through holes V12 and thereby brings the receiving space 31 into the sealed state.

A detailed description of how the boiler body is displaced with respect to the lid is given below with reference to FIG. 6-1 to FIG. 6-3, which show different states of the boiler structure during operation respectively.

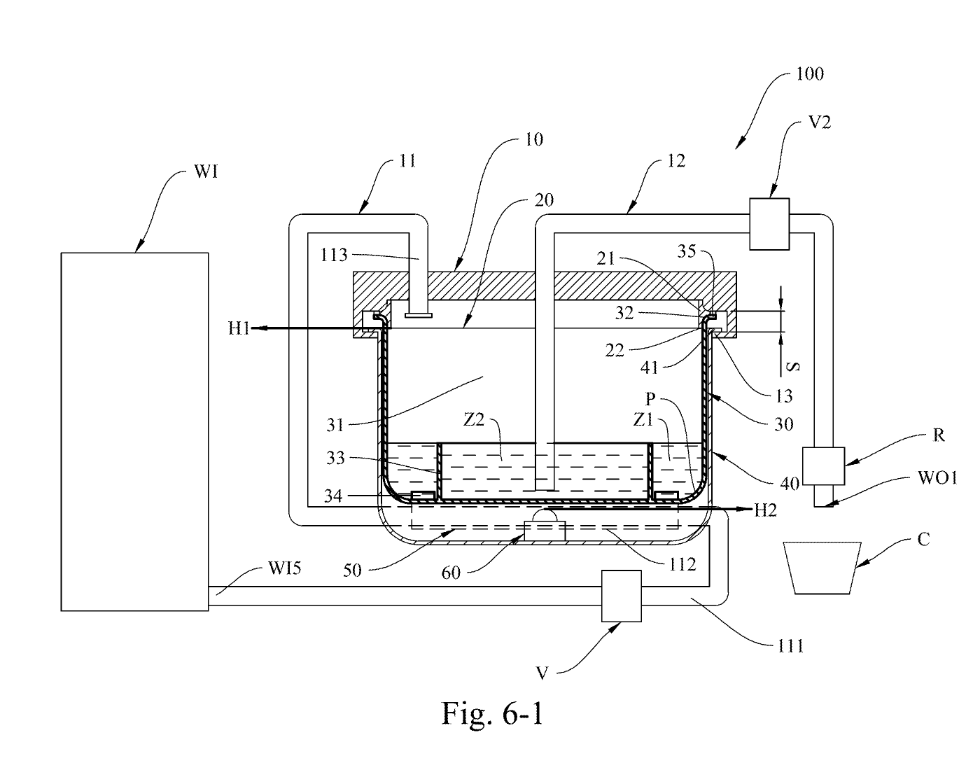

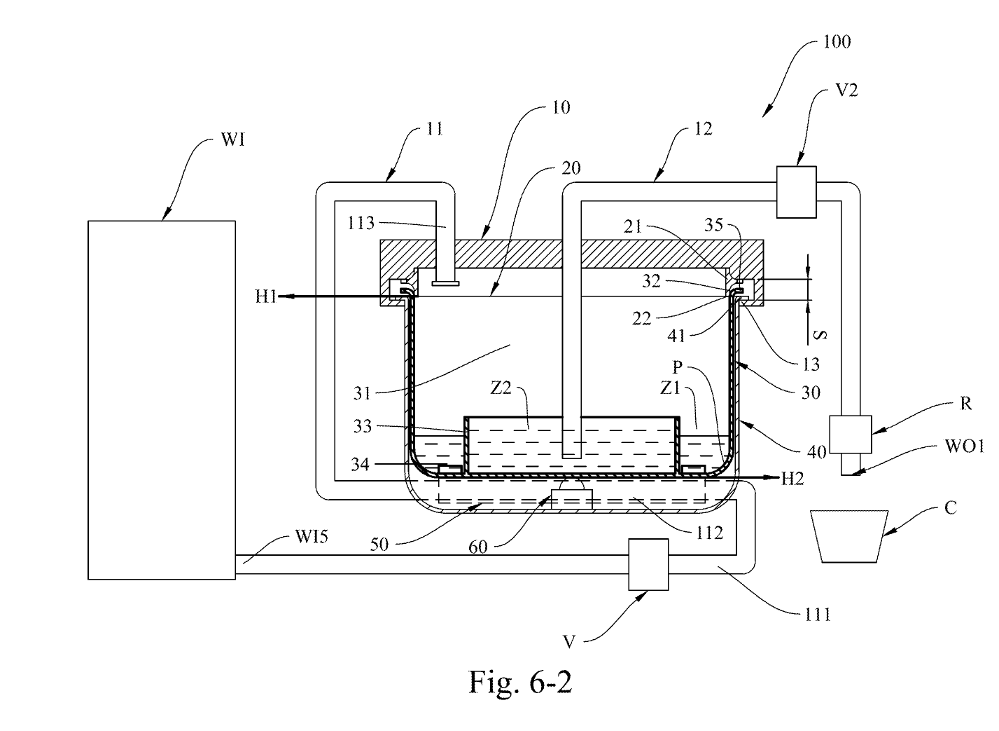

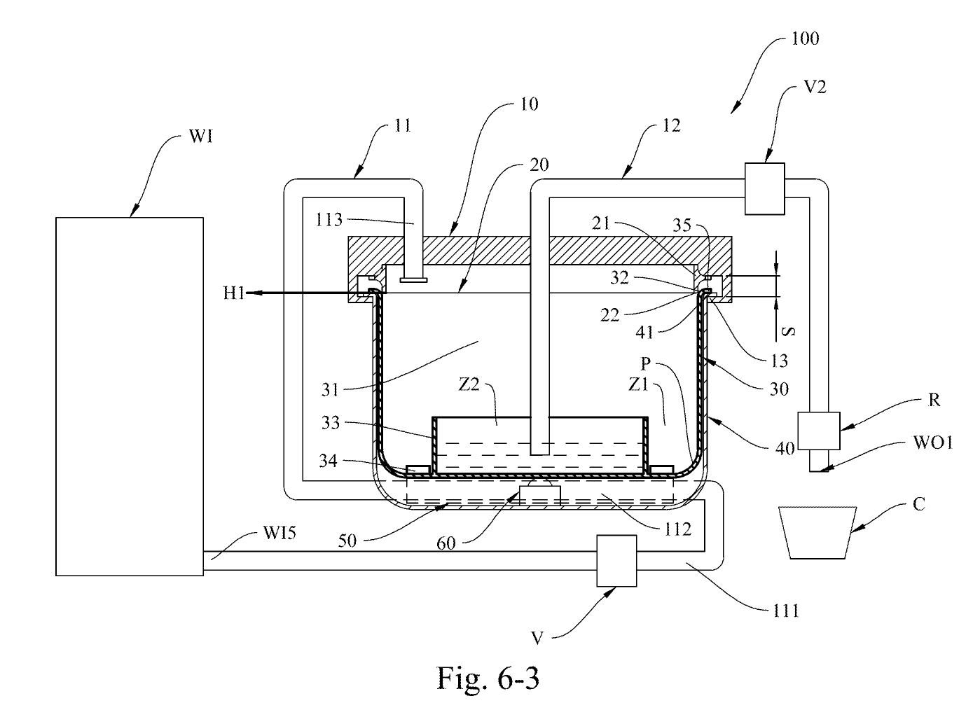

To begin with, referring to FIG. 6-1, the water in the water tank WI is driven by gravity through the water inlet section 111 into the preheating section 112, where the water is preheated by the heating device 50. The preheated water raises the pressure in the water outlet section 113 to such an extent that the water is guided into the steam generation area Z1 and the hot water generation area Z2 of the boiler body 30. While the heating device 50 continues heating the boiler body 30 (including the steam generation area Z1 and the hot water generation area Z2), the heater 34 in the steam generation area Z1 heats the water therein in order for the boiler body 30 to generate steam and hot water at the same time.

Referring to FIG. 6-2, when the internal pressure of the boiler body 30 rises, the boiler body 30 descends with respect to the lid 10 in response to the pressure variation and thereby regulates the pressure. When the descending boiler body 30 reaches the triggering height H2, the opening 32 is still higher than the pressure relief height H1, where the one or more pressure relief apertures 22 lie, so the receiving space 31 stays sealed. In the meantime, the pressure control device 60 turns off the heating device 50 to stop the heating device 50 from heating the boiler body 30. Also, the pressure control device 60 opens the water outlet valve V2 in the water outlet pipe 12 to allow water discharge through the water outlet pipe 12.

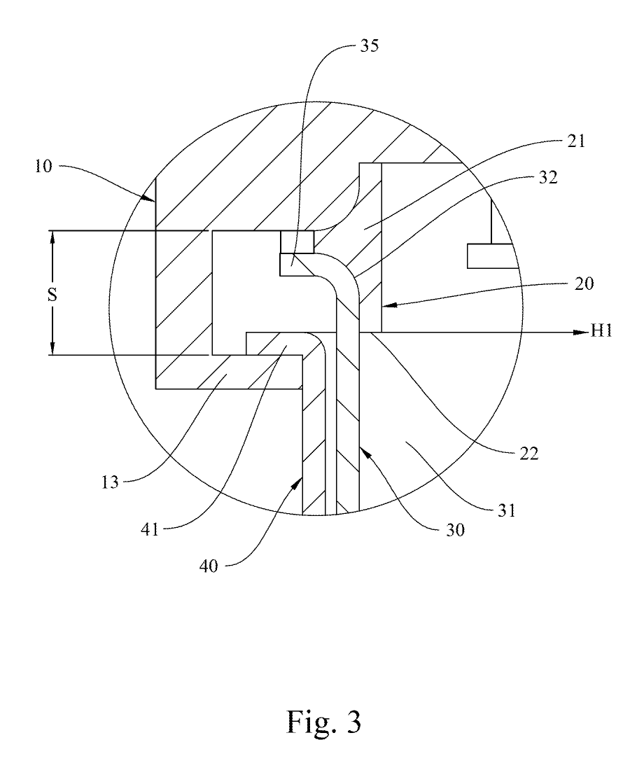

Referring to FIG. 6-3, if the internal pressure of the boiler body 30 is still on the rise but the water outlet valve V2 fails to open, the boiler body 30 will keep descending until the opening 32 reaches the pressure relief height H1, i.e., where the one or more pressure relief apertures 22 are located, allowing the steam in the boiler body 30 to discharge through the one or more pressure relief apertures 22. The foregoing mechanism design enhances the safety of use by protecting the boiler body 30 from explosion and damage. In this preferred embodiment, the one or more pressure relief apertures 22 are one or a plurality of gaps formed between the boiler body 30 and the sealing member 20 by separating the opening 32 of the boiler body 30 from the sealing member 20. In other preferred embodiments, the one or more pressure relief apertures 22 may be one or a plurality of vent holes in the periphery of the lid 10 that are in communication with the outside to relieve pressure from inside the boiler body 30. The present invention has no limitation on how the one or more pressure relief apertures 22 are formed.

According to the above, the present invention provides a boiler body displaceable with respect to its lid so that pressure can be released from inside the boiler body when the boiler body has been displaced to the height of the pressure relief apertures, thereby preventing the boiler from explosion. In addition, a pressure control device is provided to keep the pressure and temperature of brewing water within predetermined ranges respectively, thereby enhancing the quality of the coffee brewed. Moreover, pumps can be dispensed with because a thermosiphon is provided to guide water flow, and the time required for the heating device to heat the boiler body is effectively shortened by preheating the water to be guided into the boiler body.

The above is the detailed description of the present invention. However, the above is merely the preferred embodiment of the present invention and cannot be the limitation to the implement scope of the present invention, which means the variation and modification according the present invention may still fall into the scope of the invention.

What is claimed is:

1. A boiler structure, for use with a coffee machine and capable of automatic depressurization, wherein the coffee machine has a water inlet and a water outlet, and the boiler structure is between the water inlet and the water outlet; and, the boiler structure being characterized by comprising:
a lid configured with a water inlet pipe and a water outlet pipe, wherein the water inlet pipe is configured for guiding water from the water inlet, and the water outlet pipe is configured for guiding water to the water outlet;
a sealing member fitted in an inner side of the lid and having a pressure relief ring, wherein the pressure relief ring has one or a plurality of pressure relief apertures at a pressure relief height;
a boiler body on one side of the lid, wherein the boiler body comprises a receiving space and an opening, the receiving space is in communication with the water inlet pipe and the water outlet pipe, the opening is on one side of the receiving space, the pressure relief ring is fitted in the opening to seal the opening, a heating device is on one side of the boiler body, the boiler body is movable downward by pressure while being heated by the heating device, and steam is allowed to be released from inside of the boiler body through the one or the plurality of pressure relief apertures when the opening of the boiler body reaches the pressure relief height, thereby relieving the pressure; and
a position-limiting support frame on the side of the lid such that the boiler body lies between the position-limiting support frame and the lid and is limited in displacement.

2. The boiler structure of claim 1, the water inlet pipe is connected to a water tank.

3. The boiler structure of claim 1, wherein the heating device is a thermosiphon.

4. The boiler structure of claim 2, wherein the water inlet pipe includes a water inlet section in communication with the water tank, a water outlet section in communication with the receiving space of the boiler body, and a preheating section between the water inlet section and the water outlet section and on one side of the heating device, so that water heated by the preheating section can be guided into the receiving space via the water outlet section.

5. The boiler structure of claim 2, wherein a check valve is installed between the water inlet section and the heating device.

6. The boiler structure of claim 1, wherein a pressure control device is installed in one side of the boiler body; and, when the boiler body descends to a triggering height, the pressure control device turns off the heating device to stop the heating device from heating the boiler body

7. The boiler structure of claim 6, wherein the boiler body descends to the triggering height, the opening of the boiler body is higher than the pressure relief height.

8. The boiler structure of claim 6, wherein a sealing valve is at one end of the water inlet pipe and includes a pressing member located in the receiving space; a plurality of through holes are in a wall of the water inlet pipe for guiding water into the receiving space; and the pressing member is displaced toward the lid such that the lid blocks the through holes.

9. The boiler structure of claim 1, wherein the lid is peripherally configured with one or a plurality of position-limiting members and the one or plurality of position-limiting members is apart from the inner side of the lid; and, the positioned-liming support frame is peripherally configured with one or a plurality of stopping member so that the one or a plurality of position-limiting members are engaged with the one or a plurality of stopping members respectively to support the position-limiting support frame.

10. The boiler structure of claim 9, wherein the boiler body is configured between the lid and the position-limiting support frame is peripherally configured with one or a plurality of outwardly extending members movably disposed in the space.

11. The boiler structure of claim 1, wherein an inner bottom side and an inner vertical wall of the boiler body are joined by a curved surface.

12. The boiler structure of claim 1, wherein the boiler body further comprises a partitioning member inside; the partitioning member forms a steam generation area and a hot water generation area in the boiler body, wherein the steam generation area and the hot water generation area being concentric with the boiler body; the water inlet pipe is in communication with the steam generation area in order to guide water into the steam generation area; the water outlet pipe is in communication with the hot water generation area in order to guide hot water out of the hot water generation area; at least one heater is configured in the steam generation area to generate steam by heating the water in the steam generation area in a concentrated manner; and, the heating device heats the water in the hot water generation area continuously to generate hot water.

13. The boiler structure of claim 1, wherein the position-limiting support frame is a boiler housing.
